(19) United States
(12) Patent Application Publication
(10) Pub. No.: US 2024/0272451 A1
(43) Pub. Date: Aug. 15, 2024

(54) Optical System and Method for Image Stabilization of such an Optical System

(71) Applicant: Acuvi AB, Uppsala (SE)

(72) Inventor: Andreas DANELL, Vattholma (SE)

(21) Appl. No.: 18/570,127

(22) PCT Filed: Jun. 14, 2022
(86) PCT No.: PCT/SE2022/050580

§ 371 Date: Dec. 14, 2023

(30) Foreign Application Priority Data
Jun. 15, 2021 (SE) 2150771-0

(51) Int. Cl. G02B 27/64; G03B 5/00; H02N 2/10

(52) U.S. Cl. CPC G02B 27/64; G03B 5/00; H02N 2/103; G03B 2205/0007; G03B 2205/0061

(57) ABSTRACT

An optical system is disclosed, comprising an image sensor (110) having a sensor surface (112) configured to be positioned perpendicular to an optical axis (A) of a lens system (120), and a mechanical image-stabilization arrangement (130) for changing a relative position between said lens system and said image sensor. The mechanical image-stabilization arrangement comprises two actuator sets (131, 132), each of which being capable of providing a moving force for changing the relative position in two transverse translation directions perpendicular to the optical axis as well as in one rotational direction. having an axis of rotation parallel to the optical axis. A method for image stabilization of such an optical system is also disclosed.

### TECHNICAL FIELD

The invention disclosed herein generally relates to image stabilization. More precisely, it relates to an optical system comprising a mechanical image-stabilization arrangement as well as a method for image stabilization of such an optical system.

### BACKGROUND

Image stabilization is a technique for reducing blurring associated with the motion of a camera during exposure. The image stabilization may for example be lens-based, wherein the lens element may be moved orthogonally to its optical axis to correct for movements of the camera. The lens element may for example be moved using electromagnets, which may be controlled based on input from movement sensors. In further examples the image stabilization may involve sensor-shift, wherein the image sensor capturing the image is moved in such way as to counteract the motion of the camera.

The general strive for reduced device dimensions and improved performance makes it a challenging task to provide image stabilization techniques that meet the demands, especially in the smartphone industry. There is therefore a need for alternative and improved techniques for image stabilization.

### SUMMARY

It is an object of the present invention to provide an optical system and a method for image stabilization. Further and/or alternative objectives may be understood from the following.

According to an aspect of the present invention, there is provided an optical system comprising an image sensor having a sensor surface configured to be positioned perpendicular to an optical axis of a lens system. Further, the optical system comprises a mechanical image-stabilization arrangement, which is configured for changing a relative position between the lens system and the image sensor in reply to a control signal. The relative position may be allowed to change in at least two transverse translation directions perpendicular to the optical axis as well as in a rotation direction, having an axis of rotation parallel to the optical axis. The mechanical image-stabilization arrangement may comprise two actuator sets, each one having at least one actuator with at least one volume of electromechanically active material that is excitable by a set of electrodes, and a single drive pad. The volumes of electromechanically active material may be elongated, having a main extension direction parallel to the sensor surface, and are excitable by the set of electrodes for performing first vibration mode of bending vibrations having strokes in a direction perpendicular to the sensor surface. The single drive pad is arranged for protruding from the volume of electromechanically active material in a direction perpendicular to the sensor surface, whereby each of the at least two actuator sets are capable of providing an actuating action in the direction of the main extension direction. The mechanical image-stabilization arrangement further comprises drive members having drive surfaces, arranged parallel to the sensor surface, against which the single drive pad is arranged to apply a moving force. In one configuration the drive members are mechanically secured to the image sensor whereas the two actuator sets are configured to be mechanically secured to the lens system. In another configuration the drive members are configured to be mechanically secured to the lens system whereas the two actuator sets are configured to be mechanically secured to the lens system.

According to a second aspect a method for image stabilization of an optical system is provided, comprising obtaining a detected motion of an image sensor with a sensor surface positioned perpendicular to an optical axis of a lens system, and determining a compensation movement of a relative position between the lens system and the image sensor for compensating for said detected motion. The relative position is allowed to change in two transverse translation directions perpendicular to the optical axis as well as in a rotational direction, having an axis of rotation parallel to the optical axis. The method further comprises providing a control signal to a mechanical image-stabilization arrangement, configured for changing the relative position. As outlined above, the mechanical image-stabilization arrangement may comprise two actuator sets, each one having at least one actuator with at least one volume of electromechanically active material that is excitable by a set of electrodes, and a single drive pad. The volumes of electromechanically active material have a main extension direction parallel to said sensor surface and are excitable by the set of electrodes for performing first vibration mode of bending vibrations having strokes in a direction perpendicular to the sensor surface. The single drive pad is arranged for protruding from the volume of electromechanically active material in a direction perpendicular to the sensor surface, whereby each of the two actuator sets are capable of providing an actuating action in the direction of the main extension direction. The mechanical image-stabilization arrangement further comprises drive members having drive surfaces, parallel to said sensor surface, against which the single drive pad is arranged to apply a moving force. The step of providing a control signal comprises providing of electrical signals to the set of electrodes.

According to some embodiments the volumes of electromechanically active material may be additionally excitable by the electrodes for performing a second vibration mode of vibrations having strokes perpendicular to the main extension direction. The second vibration mode may provide an actuating action in a direction perpendicular to the main extension direction and parallel to the sensor surface.

The present invention makes use of the fact that by providing at least two actuator sets and operating them such that two transverse actuating actions in a direction perpendicular to the main extension direction are made available, the sensor may be both translated and rotated with reference to the optical axis, i.e., translated orthogonally to the optical axis and rotated around the optical axis. The two transverse actuating actions may be provided by different approaches. The actuator sets may for example be arranged at an angle to each other, such as perpendicular, whereby the image sensor may be translated in one direction by operating a first one of the actuator sets and in another direction by operating the second one of the actuator sets. Rotation may in such case be provided by operating each actuator both sets in a first vibration mode along the respective length direction of the volumes of electromechanically active material. The actuator sets may also be arranged parallel to each other. A least one of the actuator sets is then excitable also in a second vibration mode to provide an actuating action in a direction perpendicular to the length direction. Thereby the image sensor may be translated along the length direction when the actuator sets are operated in the first vibration mode and along the transverse direction (with respect to the length direction) when the actuators sets are operated in the second mode. Rotational movement may in such case be provided by operating the actuator sets in different directions, such as opposite directions. Various configurations and operation schemes are conceivable, as will be discussed in greater detail in the following with reference to the drawings.

By allowing for the relative position between the lens system and the image sensor to be changed in two transverse translation directions perpendicular to the optical axis of the lens system as well as in one rotational direction, having an axis of rotation parallel to the optical axis, the optical system is allowed to compensate for movements not only in the plane of the sensor surface but also for rotational movements of the camera. This is advantageous over for example lens-based stabilization systems, which tend to be incapable of compensating for rotations along the optical axis. Thus, the present invention may allow for the sensor to move more freely than the lens in lens-based prior art systems.

The volumes of electromechanically active material may have a main extension direction parallel to the sensor surface, which allows for the actuator sets to be arranged at the underside of the sensor (i.e., the side opposing the sensor surface). Advantageously this may save space laterally, compared to systems wherein the actuators are arranged at the sides of the sensor. Further, the actuator sets may be provided with a relatively flat configuration which allows for the overall thickness of the optical system to be reduced. This may be particularly advantageous in handheld applications, such as smartphones, wherein the available space may be scarce.

By electromechanically active materials are generally meant materials that are capable of changing their shape in response to an applied electric voltage or current. Typical examples of electromechanically active materials include piezoelectric, electrostrictive and antiferroelectric materials. These materials could be single crystalline as well as polycrystalline or amorphous.

By drive pad is generally understood any type of portion or part that is intended to operate as the contacting portion between the volumes of electromechanically active material and the drive members. The shape and material of the drive pad may vary between different applications and may preferably be selected so as to provide an optimal performance for a given application. The drive pad therefore typically has to be adapted from case to case. In an example, the drive pad has a contact tip presenting a curvature in two transverse directions parallel to the sensor surface. The transverse directions may coincide with the length direction of the volume of electromechanically active material and a direction perpendicular to the length direction. The drive pad may be arranged at various positions along the main extension direction of a volume of electromechanically active material, such as at an end of the volume, or at a midpoint. Illustrating examples are discussed in connection with the detailed description of the drawings.

The term drive member may refer to a structural part or portion having a surface against which the drive pad may be arranged to apply a moving force and thereby provide an actuating action in the direction of the main extension and/or the direction perpendicular to the main extension direction. The drive pad and the drive member may thus be configured to cooperate to transfer an actuating action between the electromechanically active material and the image sensor. The moving force may in some examples be achieved by means of a normal-force arrangement configured to apply a normal force between the drive pads and the drive members, establishing a mechanical contact therebetween. It will be appreciated that the drive pad in one exemplary configuration may be mechanically secured to the lens system (via the actuator set) whereas the drive member may be mechanically secured to, or integrated in, the image sensor. In another exemplary configuration the drive pad may be mechanically secured to the image sensor whereas the drive member may be mechanically secured to, or integrated in, the lens system.

The two actuator sets maybe arranged on opposite sides of the optical axis and in a same plane, which preferably may be parallel to the main extension direction or length of the volumes of electromechanically active material and further parallel to the sensor surface. Arranging the two actuator sets on different sides of the optical axis may facilitate rotational movement of the image sensor around the optical axis. In further examples, the two actuator sets may be arranged outside the sensor surface, as viewed along the optical axis. In different words, the two actuator sets may be arranged at a rim or edge of the image sensor.

The optical system may further comprise a sensor configured for detecting a motion of the optical system, and a control unit, also referred to as a controller, that is communicatively connected to the image sensor and electrically connected to the electrodes. The control unit may be used for determining requested compensation movement in the two transverse translation directions perpendicular to the optical axis as well as in the rotation direction, having an axis of rotation parallel to the optical axis for mitigating image instability caused by the detected motion. The control unit may further be configured to provide electrical signals to the electrodes for causing the mechanical image-stabilization arrangement to perform the compensation movements.

The invention may be embodied as computer-readable instructions for controlling a programmable computer in such manner that it performs the control method outlined above. Such instructions may be distributed in the form of a computer-program product comprising a computer-readable medium storing the instructions. In particular, the instructions may be loaded in a control unit responsible for supplying an electrical signal controlling the operation of the mechanical image-stabilization arrangement.

Further objectives of, features of and advantages with the present invention will become apparent when studying the following detailed disclosure, the drawings and the appended claims. Those skilled in the art realize that different features of the present invention, even if recited in different claims, can be combined in embodiments other than those described in the following.

### BRIEF DESCRIPTION OF DRAWINGS

The above, as well as additional object, features and advantages of the present invention will be better understood through the following illustrative and non-limiting detailed description of embodiments of the present invention. Reference will be made to the appended drawings, on which:

FIG. 1 graphically illustrates a cross sectional side view of an optical system in accordance with an embodiment;

FIGS. 2a and 2b are perspective views of a volume or an electromechanically active material enabled to perform two bending vibration modes;

FIGS. 3a and 3b schematically outline exemplary configurations of the actuators relative to the image sensor in accordance with some embodiment of the present invention;

FIG. 4 is a bottom view of an actuator comprising a set of electrodes in accordance with an embodiment;

FIG. 5 is a perspective view of an optical system in accordance with an embodiment;

FIG. 6 is a cross sectional side view of an optical system in accordance with an embodiment;

FIG. 7 is a schematic outlining an optical system comprising a motion sensor and a control unit in accordance with an embodiment; and

FIG. 8 is a flowchart of a method for image stabilization of an optical system in accordance with an embodiment.

All the figures are schematic and generally only show part which as necessary in order to elucidate the invention, whereas other part may be omitted or merely suggested.

### DETAILED DESCRIPTION

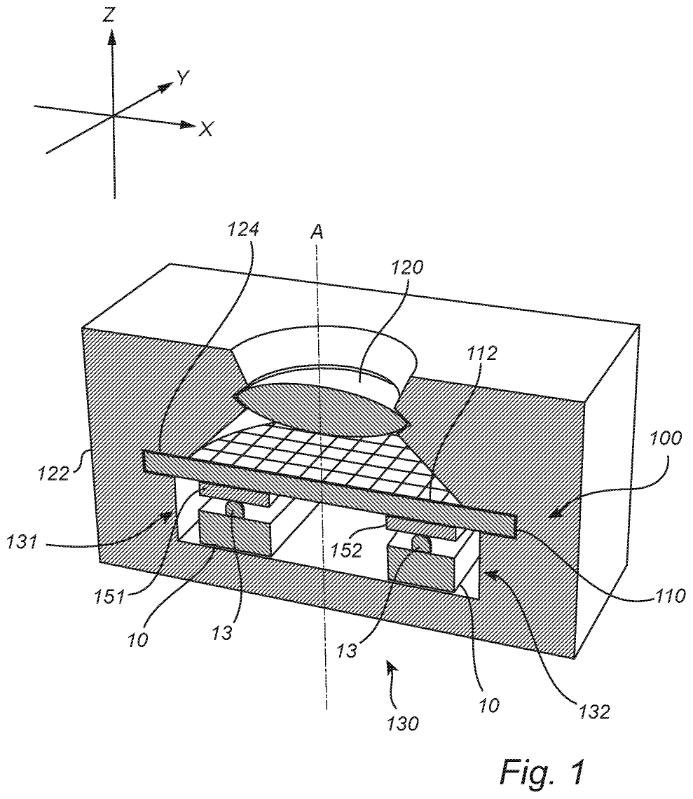

FIG. 1 is a schematic sideview of an optical system 100 according to an embodiment of the present invention. The optical system 100 comprises an image sensor 110 having a sensor surface 112 configured to be positioned perpendicular to an optical axis A of a lens system 120. It will be appreciated that the lens system 120 in some examples may form part of the optical system 100, while it in other examples may be provided as a separate item not forming part of the optical system 100. The lens system 120 and the optical system 100 may for example be implemented in the camera of an electronic device, such as a smartphone.

The optical system 100 further comprises a mechanical image-stabilization arrangement 130 for changing a relative position between the lens system 120 and the image sensor 110 to compensate for mechanical movement of the camera relative the object that is being imaged. The change in relative position may be performed in reply to a control signal indicating a movement of the camera and thus the lens system 120. The image-stabilization arrangement 130 comprises two actuator sets 131, 132, each of which having at least one actuator with a volume 10 of electromechanically active material, which is excitable by a set of electrodes (not shown), and a drive pad 13. The drive pad 13 may be arranged protrude from the volume 13 and is configured to provide an actuating action along a main extension direction of the volume 13. The drive pad 13 is further configured to engage a drive member 151, 152 so as to apply a moving force to the drive member and thereby transfer the actuating action to the drive member 151, 152. As indicated in FIG. 1 the drive member 151, 152 may be structurally arranged between the image sensor 110 and the volume 13 so as to allow the image sensor 110 to be moved in response to the actuating action provided by the drive pad 13. In the present example the drive member 151, 152 may be mechanically secured to (or structurally integrated with) the image sensor 110 while the actuator sets 131, 132 are mechanically secured to the lens system 120, in this case indirectly via a housing 122 of the lens system 120. It will however be appreciated that the drive members 151, 152 in alternative configurations may be mechanically secured to (or structurally integrated with) the lens system 120, whereas the actuator sets 131, 132 may be mechanically secured to (or structurally integrated with) the image sensor 110. The housing 122 may further comprise a guiding arrangement 124 for assisting in maintaining the sensor surface 112 perpendicular to the optical axis A, and yet allow for a translational movement of the image sensor 110 in the lateral direction.

In order to specify the different directions involved in the optical system 100 a local coordinate system may be defined, which will be used for explaining the different directions throughout the present disclosure. The optical system 100 is configured to move the image sensor 110 in two transverse translation directions intersecting the optical axis A as well as in one rotational direction around the optical axis A. The two transverse translation directions may be parallel to a plane in which the sensor surface 112 of the image sensor 110 is arranged, and may hence be perpendicular to the optical axis A. Points on the sensor surface 112 may be described by the x- and y-directions in a local coordinate system indicated in FIG. 1.

Consequently, the optical axis A and a normal to the sensor surface may extend along the z-direction in the local coordinate system.

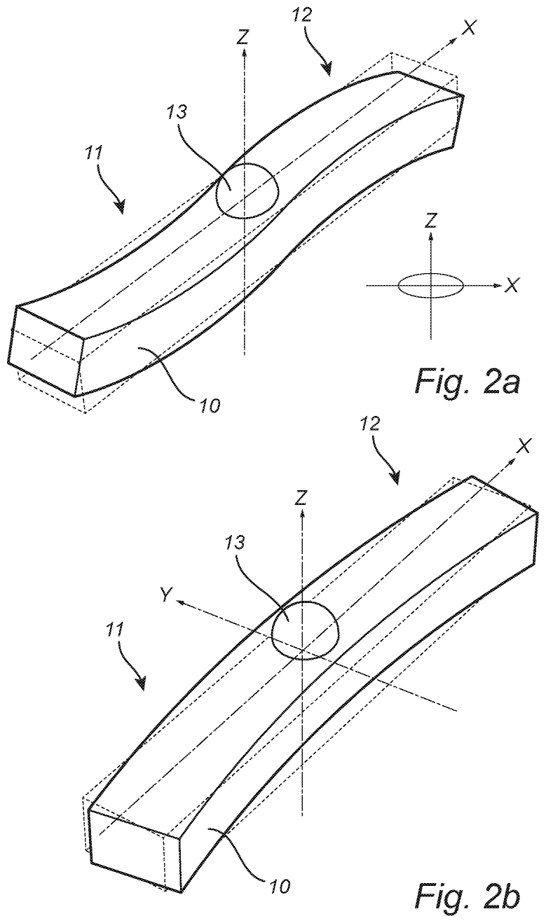

The operation of the optical system 100 and exemplary details concerning different parts of the optical system 100 will now be described with reference to FIGS. 2a and 2b. FIGS. 2a and 2b are schematic perspective views of a volume 10 of electromechanically active material, such as a piezoelectric material. The volume 10 may form part of an actuator set 131, 132, which may be similarly configured as the actuator sets 131, 132 discussed above in connection with FIG. 1. Hence, the volume 10, which may have an elongated shape, can be arranged with a main extension direction or length in a plane parallel to the sensor surface 112. In different words, the volume 10 can be oriented such that its length direction extends in the xy-plane described by the local coordinate system in FIG. 1. The volume 10 may be formed of two bending sections 11, 12 with a drive pad 13 at an intermediate position. In other words, the bending sections 11, 12 may be arranged in series along the length direction and may be bendable along a normal to the sensor surface 112 of the image sensor 110, i.e., the z-axis. In the present example the bending sections 11, 12 may be formed by bimorph piezoelectric elements comprising two parallel and individually excitable active volumes, whereby a bending action is achieved by providing the active volumes with different voltages or currents via electrodes (not shown).

The actuator 131, 132 formed by the volume 10 and the drive pad 13 may be operated in a first vibration mode in which the bending of the respective bending sections 11, 12 are performed with a phase-difference with respect of each other being different from 0 or 180 degrees, preferably close . The tip of the drive pad 13 will thereby perform an elliptical movement in the x-z plane, thereby providing an actuating action in the length direction of the volume 10, i.e., the x-axis in the present example. This actuation action may be transferred to the image sensor via drive members 151, 152, against which the drive pad 13 is arranged to apply the moving force. The actuator is typically driven by a voltage applied over a portion of the volume 10, which responds by bending (please note that the movement for illustrative purposes is heavily exaggerated in the drawings). FIG. 2a illustrates the behavior at a second order resonance frequency, wherein the volume 10 would start to vibrate in a resonant manner with nodal positions close to its ends and below the drive pad 13 as seen in the z-direction. This corresponds to a driving of the bending sections 11, 12 phase-shifted up to 180 degrees. In order to achieve a movement of the drive pad 13 in the z-direction, the driving of the bending sections 11, 12 may be performed with another phase shift causing the drive pad 13 to move also in the z-direction, thus move along an elliptical trajectory as indicated in the diagram in FIG. 2a. The combination of movements of the drive pad 13 along the x-axis and the z-axis may therefore result in a movement of the drive pad 13 along an elliptical trajectory causing the image sensor 110 to move along the x-axis. An example of the elliptical trajectory is indicated in the diagram in FIG. 2a.

The actuator may additionally be excitable for performing a second vibration mode of vibrations having strokes perpendicular to the main extension direction, i.e., such as the y-direction as indicated in the example of FIG. 2b. For this purpose, the volume may comprise bending sections, for example formed by bimorphs piezoelectric elements comprising individually excitable active volume, which may be bendable sideways, i.e., along the y-axis. This may be employed to provide an actuation in a direction perpendicular to the main extension direction and parallel to the sensor surface, such that the image sensor 110 may be translated in the y-direction.

The actuator according to some examples may hence be operated or excited in two different vibrations modes: a first vibration mode of bending vibrations having strokes in a direction perpendicular to the sensor surface 112 to provide an actuating action in the length direction of the actuator, and a second vibration mode of bending vibrations having strokes perpendicular to the length direction and parallel to the sensor surface 112 to provide an actuating action perpendicular to the length direction and parallel to the sensor surface 112.

In order to facilitate the transfer of the actuating action to the drive member 151, 152 the drive pad 13 may comprise a contact tip portion presenting a curvature in two transverse directions parallel to the sensor surface. In FIGS. 2a and 2b this is illustrated by a rounded body 13, having an outer surface conforming to a half-sphere.

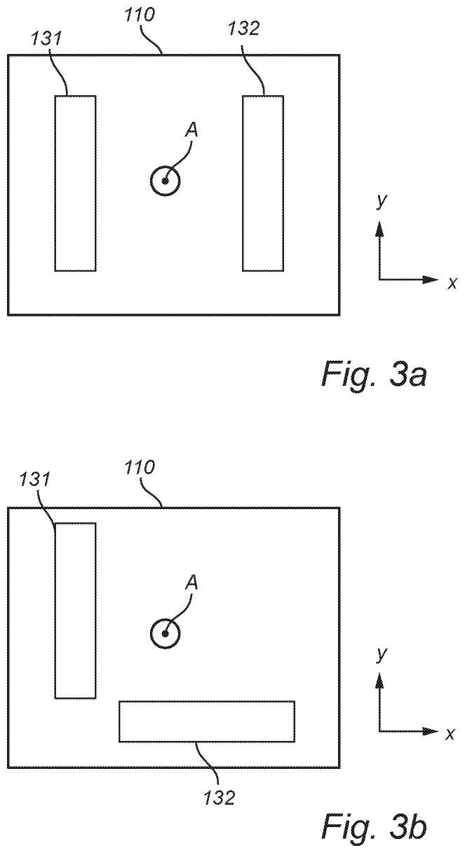

The translation of the image sensor 110 in the two transverse directions, i.e., in the xy-plane defined by the local coordinate system in FIG. 1, as well as the rotation of the image sensor around the optical axis (or z-axis) may be achieved in various ways depending on the arrangement of the actuators 131, 132 and the vibration modes in which they are operated. Two exemplary configurations are shown in FIGS. 3a and 3b, which may be similar as the embodiments disclosed in connection with FIGS. 1 and 2a-b. FIG. 3a shows a first and a second actuator set 131, 132, each having a respective volume 10 of electromechanically active material and a drive pad 13 arranged at the underside of the image sensor 110 and with their main extension direction parallel to the sensor surface 112. The image sensor 110 is hence viewed from below in FIG. 3a, in a positive direction of the z-axis. The first and second actuator sets 131, 132 are in this example arranged such that their respective drive pad 13 can apply a moving force against drive members 151, 152 that may be mechanically secured to the underside of the image sensor 110. The actuator sets 131, 132 are in the present example arranged parallel two each other and on opposite sides of the optical axis A of the lens system (not shown). A translation of the image sensor 110 along the x-axis may be provided by operating at least one of the first and second actuator sets 131, 132 in the first vibration mode, in which they may provide an actuating action in their length direction. Correspondingly, a translation of the image sensor 110 along the y-axis may be provided by operating at least one of the first and second actuator sets 131, 132 in the second vibration mode, in which they may provide an actuating action in a transverse direction, orthogonal to the length direction. Finally, a rotational movement around the optical axis A may be achieved by operating the first and second actuator sets in opposite directions, such that the first actuator set 131 provides an actuating action along the positive y-direction and the second actuator set 132 provides an actuating action along the negative y-direction. In further examples, the rotation may be provided by operating at least one of the actuator sets 131, 132 in the second vibration mode, in which it provides an actuating action transverse to the length direction. This may however require that the contact tips of the respective drive pads 13 are not arranged on a line intersecting the axis of rotation A. Thus, for such an implementation the actuator sets 131, 132 may be shifted relative to each other along the y-axis.

FIG. 3b illustrates another configuration wherein the actuator sets 131, 132 are arranged at an angle to each other, such as 90° . A translation of the image sensor 110 along the x-axis may in this example be provided by operating the second actuator set 132 in the first vibration mode for generating an actuating action along its length direction. The first actuator set 131 may be operated in the second vibration mode, if the two modes can be operated at a same frequency, wherein it generates a resulting actuating action that is transverse to its length. Alternatively, the first actuator can be operated to provide a small motion up and down in the z-direction, reducing the mechanical contact with the image sensor synchronously with the driving phase of the second actuator set 132. Conversely, a translation of the image sensor along the y-axis may be provided by operating the first actuator set 131 in the first vibration mode. The second actuator set 132 may be operating in the second vibration mode or may provide a “lifting” operation, as described above. A rotational movement may be provided by operating each actuator set 131, 132 in the first vibration mode. Further examples are and combinations are also possible, wherein the actuator sets 131, 132 are arranged non-parallel and non-orthogonal to each other.

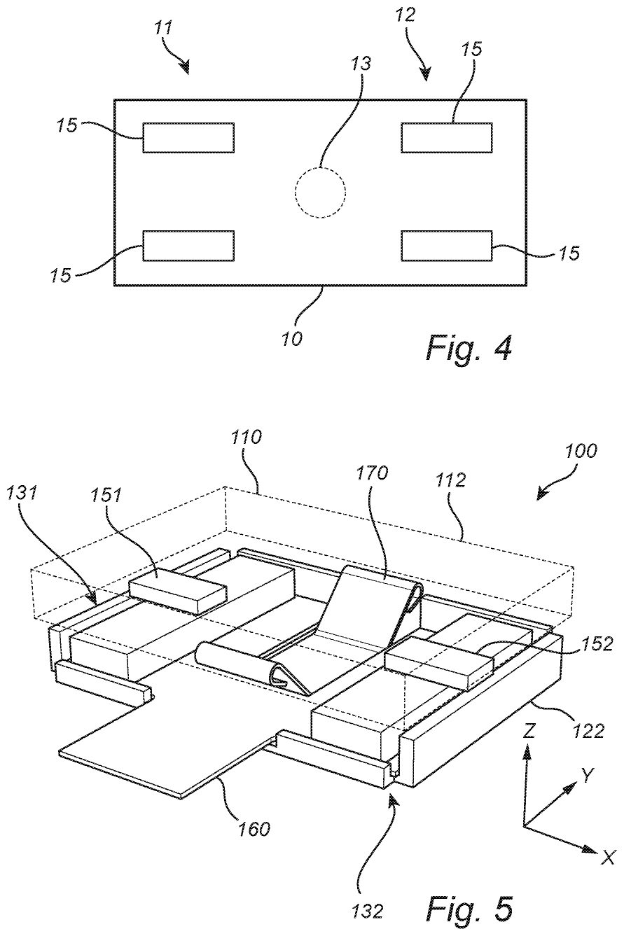

The actuator, comprising a volume 10 of electromechanically active material, may be excited by a set of electrodes 15 as illustrated in FIG. 4. The electrodes 15 may be arranged on the underside of the volume 10, i.e., the side of the volume 10 opposite to the drive pad 13, so as to facilitate electrical access. It will be appreciated that the illustrated electrodes 15 are merely an example, and that the actual configuration in terms of number and placement of the electrodes 15 may vary between different designs of the actuator. The placement of the electrodes and the pattern in which an electrical potential is applied to the electrodes may determine the resulting vibration mode in the actuator is operated and hence the direction in which the actuating action is applied to the drive members. In the present example the volume 10 of electromechanically active material may comprise individually excitable electrodes 15 provided in a same plane parallel to the sensor surface 112 but separated in a direction parallel to the main extension direction, and further separated in a direction perpendicular to the main extension direction. Thus, the electrodes 15 may be provided in a pattern wherein they are distributed both in the x-direction and the y-direction. There may further be provided electrodes 15 arranged in different planes parallel to the sensor surface 112, such as the upper side of the volume 10. In this case the electrodes may be overlapping in a direction perpendicular to the sensor surface 112. In some examples, electrodes 15 may be arranged on lateral side surfaces of the volume 10, i.e., in a plane orthogonal to the sensor surface 112. In case the electrodes are arranged in separate planes orthogonal to the sensor surface 112 they may be overlapping in a direction parallel to the sensor surface 112.

FIG. 5 is a perspective view of an optical system 100 according to an embodiment, which may be similarly configured as the embodiments discussed in connection with any of the previous figures. Thus, the optical system 100 may comprise an image sensor 110 which on its underside, i.e., the side opposite to the sensor surface 112, is mechanically secured to a first and a second drive member 151, 152. The drive members 151, 152 may comprise drive surfaces facing away from the sensor surface 112 and arranged parallel to the sensor surface 112.

The optical system 100 further comprises two actuators 131, 132, each comprising a respective volume 10 of electromechanically active material arranged in parallel to each other and the sensor surface 112. Each of the actuators 131, 132 are arranged to mechanically contact a drive surface of a respective drive member 151, 152 so as to transfer an actuating action to the image sensor 110. The actuators 131, 132 and the drive members 151, 152 may form a mechanical image-stabilization arrangement 130, which can change a transverse and rotational position of the image sensor 110 relative to an optical axis of the lens system (not shown) in response to a control signal. The operation of the actuators 131, 132 and the generation of the translational and rotational movements may be similar to the examples discussed above and will therefore not be repeated in the description of the present figure.

The image sensor 110 may be pushed against the image-stabilization arrangement 130 by means of a normal-force arrangement configured to apply a normal between the drive pad 13 of the actuators 131, 132 and the drive members 151, 152. The normal-force arrangement may for example comprise a resilient arrangement 170 generating a force pushing the image sensor 110 downwards, in the negative z-direction. A counterforce may be provided by means of a spring member arranged in the housing or support 122 accommodating the image-stabilization arrangement, pushing the image sensor 110 upwards in the positive z-direction. The force by which the drive pads 13 abuts the drive members 151, 152 may be determined by the balance between the applied forces and affect the friction between the drive pads 13 and the drive members 151, 152 and hence the efficiency by which the actuating force can be transferred to the image sensor 110. It is therefore of interest to choose a spring member that provides a suitable force balance between the force by which the image sensor is pushed against the image-stabilization arrangement 130 (in the negative z-direction) and the counterforce acting in the positive z-direction.

The actuator sets 131, 132 may be arranged on a substrate, such as a printed circuit board 160, providing mechanical support and electrical power for operating the actuator sets 131, 132. The substrate 160 may thus comprise electrical conduction paths that can be electrically connected to contact pads on the underside of the volume 10 of electromechanically active material (i.e., the side of the volume 10 opposite to the drive pad 13).

In the present example each of the actuator sets 131, 132 may comprise a single actuator, formed by a single volume 10 of electromechanically active material, and a single drive pad 13 as illustrated in e.g. FIGS. 2a and 2b. It will however be appreciated that an actuator set 131, 132 also may comprise two or more actuators, each arranged with a respective single drive pad in contact with two opposite drive surfaces of the drive members.

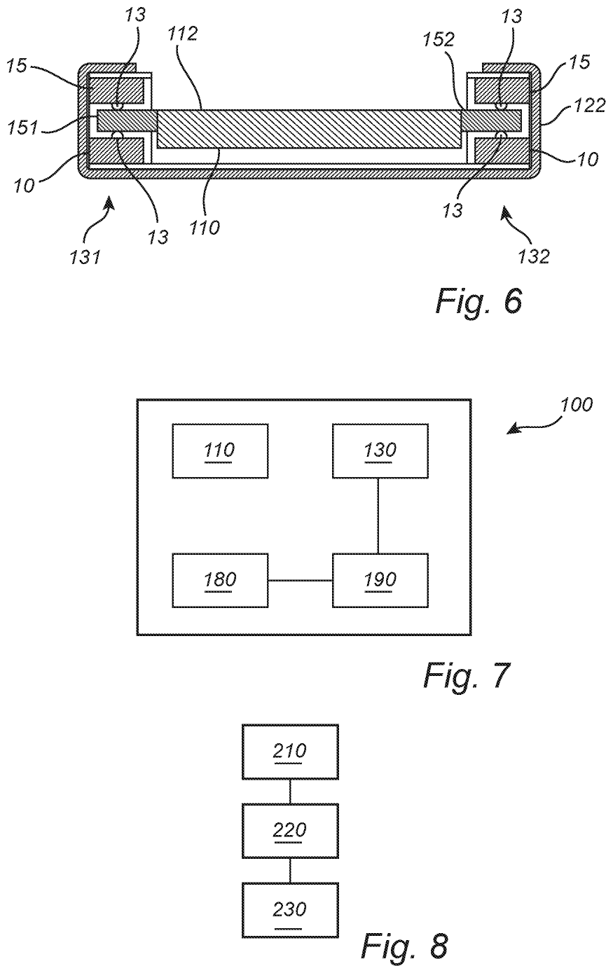

An example of such a configuration is illustrated by the cross section in FIG. 6. The cross section is taken along the z-axis of an optical system that may be similarly configured as the optical system illustrated in FIG. 5. The drive members 151, 152 are in this example arranged at the lateral sides of the image sensor 110, such that that they protrude from two opposing edges of the image sensor 110 and thus are arranged outside the sensor surface 112, as viewed along the optical axis A. Each of the drive members 151, 152 comprises a first drive surface facing downwards, in the negative z-direction and a second drive surface facing upwards, in the positive z-direction. The drive surfaces are thus parallel to the sensor surface 112 but opposing each other. Each of the actuator sets 131, 132, which may be arranged at the lateral sides of the image sensor 110, may comprise a first actuator 10 configured to transfer an actuating action to the downward-facing drive surface and a second actuator 15 configured to transfer an actuating action to the upward-facing drive surface. Thus, the first actuators 10 of each actuator set 131, 132 may be arranged below the respective drive members 151, 152 and the second actuators 15 of each actuator set 131, 132 may be arranged above the respective drive members 151, 152 as view along the z-axis. The actuators of the actuator sets 131, 132 may be operated in a similar manner as outlined above in connection with the previous figures, and may hence be used for applying an actuating action allowing the image sensor 110 to be translated in a plane orthogonal to the optical axis A and further rotated around the optical axis A.

FIG. 7 is a schematic illustration of an optical system 100 according to an embodiment, comprising an image sensor 110 and a mechanical image-stabilization arrangement 130 which may be similarly configured as the embodiments discussed with reference to FIGS. 1-6. As indicated in the present figure the system 100 may further comprise a sensor 180 for detecting a motion of the optical system 100 and a control unit 190, wherein the control unit 190 is communicatively connected to the motion sensor 180 and electrically connected to the set of electrodes 15 by means of which the actuator sets 131, 132 can be operated. The motion sensor 180 may for example be an accelerometer or a gyroscope configured to detect a motion of the system 100, preferably relative to an object to be imaged. The control unit 190 may be configured to determine a compensation movement in the two translation directions perpendicular to the optical axis A, i.e., the xy-plane in the previously described local coordinate system, as well as in the rotation direction around the optical axis A, based on input from the motion sensor 180. The control unit 190 may further be configured to provide the required electrical signal to the set of electrodes 15 for causing the mechanical image-stabilization arrangement 130 to perform the compensation movements and thus allow for the acquired image to be stabilized.

The present invention may hence provide a method for image stabilization as illustrated in the flowchart of FIG. 8, including obtaining 210 a detected motion of the image sensor 110 and determining 220 a compensation movement of a relative position between the lens system 120 and the image sensor 110 for compensating for the detected motion. The method may further comprise providing 230 a control signal to the mechanical image-stabilization arrangement 130 configured to changing the relative position. The control signal may be provided in the form of electrical signals to the set of electrodes 15.

1-17. (canceled)

18. An optical system, comprising:
an image sensor, having a sensor surface configured to be positioned perpendicular to an optical axis of a lens system; and
a mechanical image-stabilization arrangement, configured for changing a relative position between said lens system and said image sensor in reply to a control signal;
said relative position being allowed to change in two transverse translation directions perpendicular to said optical axis as well as in one rotational direction, having an axis of rotation parallel to said optical axis;
said mechanical image-stabilization arrangement comprises:
two actuator sets, each one having at least one actuator with at least one volume of electromechanically active material excitable by a set of electrodes, and a single drive pad;
said volumes of electromechanically active material having a main extension direction parallel to said sensor surface and being excitable by said set of electrodes for performing first vibration mode of bending vibrations having strokes in a direction perpendicular to said sensor surface;
wherein said single drive pad is arranged for protruding from said volume of electromechanically active material in a direction perpendicular to said sensor surface;
whereby each of said two actuator sets are capable of providing an actuating action in the direction of said main extension direction; and
drive members having drive surfaces, parallel to said sensor surface, against which said single drive pad is arranged to apply a moving force;
wherein said drive members are mechanically secured to, or integrated in, said image sensor and wherein said two actuator sets are configured to be mechanically secured to said lens system; or
wherein said drive members are configured to be mechanically secured to, or integrated in, said lens system and wherein said two actuator sets are configured to be mechanically secured to said image sensor.

19. The optical system according to claim 18, wherein said drive members being mechanically secured to, or integrated in, said image sensor and said two actuator sets being configured to be mechanically secured to said lens system.

20. The optical system according to claim 18, wherein said two actuator sets are configured to be provided on opposite sides of said optical axis in a same plane, parallel to said main extensions direction.

21. The optical system according to claim 18, wherein each of said single drive pads has a contact tip presenting a curvature in two transverse directions parallel to said sensor surface.

22. The optical system according to claim 18, wherein said volumes of electromechanically active material being additionally excitable by said electrodes for performing second vibration mode of vibrations having strokes perpendicular to said main extension direction.

23. The optical system according to claim 22, wherein said second vibration mode provides an actuating action in a direction perpendicular to said main extension direction but parallel to said sensor surface.

24. The optical system according to claim 18, further comprising a guiding arrangement configured to be arranged between said lens system and said image sensor configured to assist in maintaining said sensor surface perpendicular to said optical axis.

25. The optical system according to claim 18, wherein each of said two actuator sets comprises a single actuator and in that said mechanical image-stabilization arrangement further comprises a normal-force arrangement configured to apply a normal force between said single drive pad of said single actuators and said drive members.

26. The optical system according to claim 18, wherein each of said two actuator sets comprises two actuators each arranged with respective said single drive pad in contact with said drive surfaces on opposite sides of said drive members.

27. The optical system according to claim 18, wherein said two actuator sets are arranged outside, as viewed along said optical axis, said sensor surface.

28. The optical system according to claim 18, wherein said set of electrodes provided on said volumes of electromechanically active material in each actuator comprises:
individually excitable electrodes provided in a same plane parallel to the sensor surface, but separated in a direction parallel to said main extension direction,
individually excitable electrodes provided in a same plane parallel to the sensor surface, but separated in a direction perpendicular to said main extension direction, and
individually excitable electrodes provided in different planes parallel to the sensor surface, but overlapping in a direction perpendicular to said sensor surface.

29. The optical system according to claim 18, further comprising:
a sensor configured for detecting a motion of said optical system; and
a control unit, communicationally connected to said sensor and electrically connected to said set of electrodes;
said control unit being configured for determining requested compensation movements in said two transverse translation directions perpendicular to said optical axis as well as in said rotational direction, having an axis of rotation parallel to said optical axis for mitigating image instability caused by said detected motion and for providing electrical signals to said set of electrodes for causing said mechanical image-stabilization arrangement to perform said compensation movements.

30. A method for image stabilization of an optical system, the method comprising:
obtaining a detected motion of an image sensor with a sensor surface positioned perpendicular to an optical axis of a lens system;
determining a compensation movement of a relative position between said lens system and said image sensor for compensating for said detected motion;
said relative position being allowed to change in two transverse translation directions perpendicular to said optical axis as well as in one rotational direction, having an axis of rotation parallel to said optical axis; and
providing a control signal to a mechanical image-stabilization arrangement, configured for changing said relative position;
said mechanical image-stabilization arrangement comprises:
two actuator sets, each one having at least one actuator with at least one volume of electromechanically active material excitable by a set of electrodes, and a single drive pad;
said volumes of electromechanically active material having a main extension direction parallel to said sensor surface and being excitable by said set of electrodes for performing first vibration mode of bending vibrations having strokes in a direction perpendicular to said sensor surface;
wherein said single drive pad is arranged for protruding from said volume of electromechanically active material in a direction perpendicular to said sensor surface;
whereby each of said two actuator sets are capable of providing an actuating action in the direction of said main extension direction; and
drive members having drive surfaces, parallel to said sensor surface, against which said single drive pad is arranged to apply a moving force;
whereby said step of providing a control signal comprises providing of electrical signals to said set of electrodes.

31. The method according to claim 30, wherein said two actuator sets are provided on opposite sides of said optical axis in a same plane, parallel to said main extensions direction, wherein said step of providing a control signal comprises providing of electrical signals to said set of electrodes of said two actuators independently of each other, in dependence on said determined compensation movement.

32. The method according to claim 31, wherein said step of providing a control signal comprises providing, to said set of electrodes of said two actuators, of electrical signals causing said two actuators to provide driving actions in a same direction parallel to said main extension direction, as a response of a determined compensation movement comprising a translation component parallel to said main extension direction.

33. The method according to claim 31, wherein said step of providing a control signal comprises providing, to said set of electrodes of said two actuators, of electrical signals causing said two actuators to provide driving actions in opposite directions parallel to said main extension direction, as a response of a determined compensation movement comprising a rotation parallel to said optical axis.

34. The method according to claim 31, wherein said volumes of electromechanically active material being additionally excitable by said electrodes for performing second vibration mode of vibrations having strokes perpendicular to said main extension direction, whereby said second vibration mode provides an actuating action in a direction perpendicular to said main extension direction but parallel to said sensor surface, wherein said step of providing a control signal comprises providing, to said set of electrodes of said two actuators, of electrical signals causing said two actuators to provide driving actions in a same direction perpendicular to said main extension direction, as a response of a determined compensation movement comprising a translation component perpendicular to said main extension direction.
